(19) United States
(12) Patent Application Publication
(10) Pub. No.: US 2026/0214329 A1
(43) Pub. Date: Jul. 23, 2026

(54) IMAGE PICKUP APPARATUS CAPABLE OF PROVIDING IMAGE FILE THAT ALLOWS TO CONFIRM STATE BEFORE PROCESSING WHEN SETTING FOR IMAGE PROCESSING SATISFIES PREDETERMINED CONDITION IN NO TAMPERING MODE, CONTROL METHOD FOR IMAGE PICKUP APPARATUS, AND STORAGE MEDIUM

(71) Applicant: CANON KABUSHIKI KAISHA, Tokyo (JP)

(72) Inventor: DAIYU UENO, Tokyo (JP)

(21) Appl. No.: 19/443,938

(22) Filed: Jan. 8, 2026

(30) Foreign Application Priority Data
Jan. 21, 2025 (JP) 2025-008474

(51) Int. Cl. H04N 23/667; G06F 21/60; G06F 21/64; H04N 23/63

(52) U.S. Cl. CPC H04N 23/667; G06F 21/602; G06F 21/64; H04N 23/634

(57) ABSTRACT

An image pickup apparatus includes an image pickup unit, a processor, and a memory. The memory stores instructions that, when executed by the processor, cause the processor to switch a no tampering mode for generating an image file, which includes image data generated by the image pickup unit and history information for certifying credibility of the image data, between enabled and disabled; perform an image processing with respect to the image data based on a setting for an image processing, and generate an image file including at least the image data. When the no tampering mode is enabled and the setting for the image processing satisfies a predetermined condition, an image file including the image data and the history information is generated, and the history information includes at least image data before the image processing is performed and image data that has been subjected to the image processing.

### BACKGROUND

### Field of the Technology

The present disclosure relates to an image pickup apparatus, a control method for the image pickup apparatus, and a storage medium.

### Description of the Related Art

In recent years, information sharing via the Internet has become more prevalent, allowing anyone to publish and disseminate a variety of information to an unspecified number of people. In addition, it has become possible to perform various kinds of processing with respect to image data. In such a situation, information may have been disseminated from an untrustworthy source (untrustworthy provenance) or publicly available information may have been fraudulently tampered (altered).

Conventionally, a technique has been proposed in which a digital camera that has performed photographing in a no tampering mode (a tampering prevention mode) generates a hash value based on image data that has been obtained by this photographing and adds the generated hash value to the image data, thereby making it possible to detect tampering with the image data (for example, see Japanese Laid-Open Patent Publication (kokai) No. 2008-5421).

In addition, conventionally, it has been proposed to, in order to authenticate the provenance, a history, or the like of image data, add, to the image data, history information indicating the content of edits that have been made with respect to the image data (see Coalition for Content Provenance and Authenticity (C2PA), “C2PA Specifications”, <Technical Specifications Version 1.2>, [online], November 3, 2022, [retrieved January 23, 2023], Internet <URL: https://c2pa.org/specifications/specifications/1.2/specs/C2PA_Specification.html>).

The digital camera that has performed the photographing in the no tampering mode is also capable of performing an image processing with respect to the image data that has been obtained by the photographing, based on a setting for an image processing that has been performed by a photographer. For example, by including image data after processing (processed image data) in history information to be added to image data that has been obtained by the image processing, it is possible to easily detect tampering with the image data after processing (tampering with the processed image data).

However, since a change from before processing will become large depending on the setting for the image processing, the photographer or a viewer may want to confirm (check) a state before processing. In such a case, since the history information, which has the above configuration, includes only the image data after processing, the photographer or the viewer is not able to confirm (check) the state before processing.

### SUMMARY

Embodiments of the present disclosure provide mechanisms capable of providing an image file that allows confirmation of a state before processing in a case where a setting for an image processing satisfies a predetermined condition in a no tampering mode.

Accordingly, an aspect of the present disclosure provides an image pickup apparatus comprising an image pickup unit, at least one processor, and a memory coupled to the at least one processor. The memory stores instructions that, when executed by the at least one processor, cause the at least one processor to switch a no tampering mode for generating an image file, which includes image data that has been generated by the image pickup unit and history information for certifying credibility of the image data, between enabled and disabled; perform an image processing with respect to the image data based on a setting for an image processing that has been performed by a photographer, and generate an image file that includes at least the image data. In a case where the no tampering mode is enabled and the setting for the image processing satisfies a predetermined condition, an image file that includes the image data and the history information is generated, and the history information includes at least image data before the image processing is performed and image data that has been subjected to the image processing.

Features of various embodiments will become apparent from the following description of embodiments with reference to the attached drawings. The following description of embodiments is described by way of example.

### BRIEF DESCRIPTION OF THE DRAWINGS

FIG. 1A and FIG. 1B are external-appearance views of a digital camera as an example of an image pickup apparatus according to an embodiment of the present disclosure.

FIG. 2 is a block diagram that illustrates an example of the configuration of the digital camera shown in FIG. 1A and FIG. 1B.

FIG. 3 is a flowchart that illustrates the procedure of a main processing executed by the digital camera shown in FIG. 1A and FIG. 1B.

FIG. 4 is a flowchart that illustrates the procedure of an image processing setting processing performed in S306 of FIG. 3.

FIG. 5 is a flowchart that illustrates the procedure of a still image photographing processing performed in S310 of FIG. 3.

FIG. 6A, FIG. 6B, and FIG. 6C are configuration diagrams that illustrate examples of the structure of an image file generated by the digital camera shown in FIG. 1A and FIG. 1B.

FIG. 7A, FIG. 7B, and FIG. 7C are diagrams that illustrate examples of screens displayed on a display unit shown in FIG. 2.

### DESCRIPTION OF THE EMBODIMENTS

The present disclosure will now describe some example embodiments in detail with reference to the accompanying drawings.

Hereinafter, an embodiment of the present disclosure will be described with reference to the drawings.

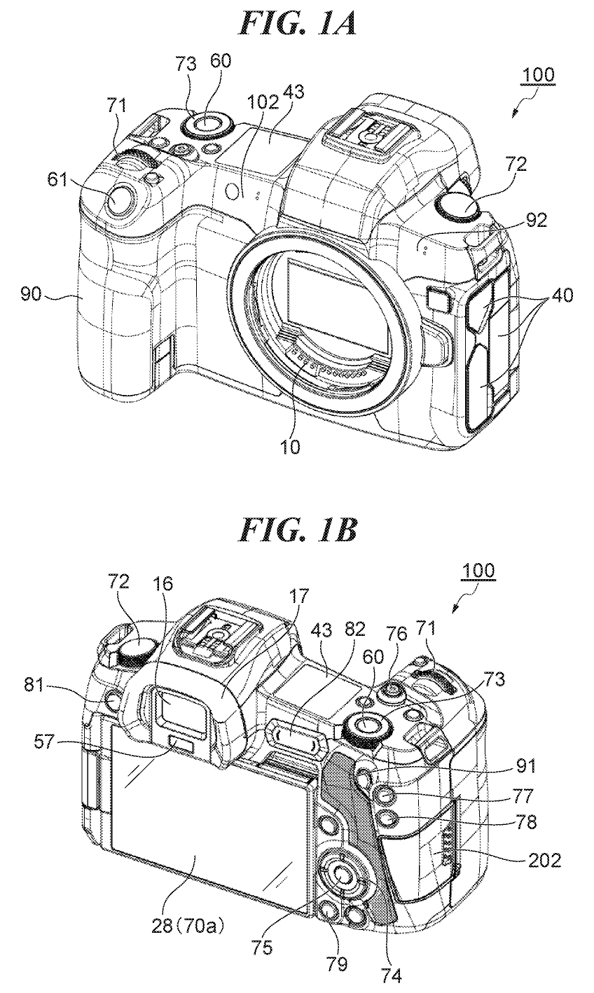

FIG. 1A and FIG. 1B show external-appearance views of a digital camera 100 as an example of an image pickup apparatus to which the present disclosure is capable of being applied. FIG. 1A is a front perspective view of the digital camera 100, and FIG. 1B is a rear perspective view of the digital camera 100.

A display unit 28 is a display unit provided on a rear surface of the digital camera 100, and the display unit 28 can display images and various kinds of information. A touch panel 70a is capable of detecting touch operations with respect to a display surface (a touch operation surface) of the display unit 28. An extra-viewfinder display unit 43 is a display unit provided on an upper surface of the digital camera 100, and the extra-viewfinder display unit 43 displays various setting values of the digital camera 100, such as a shutter speed and an aperture. A shutter button 61 is an operating member for issuing a photographing instruction. A mode change-over switch 60 is an operating member for switching between various kinds of modes. Terminal covers 40 are covers for protecting connectors (not shown) to which connection cables or the like, for connecting the digital camera 100 to external devices, can be connected.

A main electronic dial 71 is a rotary operating member, and it is possible to perform the change of the setting values, such as the shutter speed and the aperture, by rotating (turning) the main electronic dial 71. A power switch 72 is an operating member for switching the power of the digital camera 100 between on and off. A sub electronic dial 73 is a rotary operating member, and it is possible to perform operations such as moving a selection frame (a cursor) and feeding an image by rotating (turning) the sub electronic dial 73. A four-way key 74 is configured such that upper, lower, left, and right portions thereof are respectively depressible, and enables a processing corresponding to a depressed portion of the four-way key 74 to be performed. A SET button 75 is a push button and is mainly used to determine a selected item.

A moving image button 76 is used to issue instructions to start and stop moving image photographing (moving image recording). An AE lock button 77 is a push button, and it is possible to fix an exposure state by depressing the AE lock button 77 in a photographing standby state. An enlargement button 78 is an operation button for switching an enlargement mode between on and off in a live view display (an LV display) in a photographing mode. It is possible to enlarge or reduce a live view image (an LV image) by operating the main electronic dial 71 after switching on the enlargement mode. In a playback mode, the enlargement button 78 functions as an operation button for enlarging a playback image or increasing an enlargement rate of the playback image. A playback button 79 is an operation button for switching between the photographing mode and the playback mode. The playback mode is selected by depressing the playback button 79 during the photographing mode, and it is possible to cause the display unit 28 to display the latest image among images that have been recorded in a recording medium 200 that will be described below. A menu button 81 is a push button used for performing an instruction operation that causes the display of a menu screen, and the menu screen, which enables various kinds of settings to be performed, is displayed on the display unit 28 when the menu button 81 is depressed. A photographer is able to intuitively perform the various kinds of settings by using the menu screen displayed on the display unit 28 together with the four-way key 74 and the SET button 75.

A touch bar 82 (an M-Fn bar, that is, a multi-function bar) is a line-shaped touch operating member (a line touch sensor) capable of accepting a touch operation. The touch bar 82 is disposed at a position where the touch operation is capable of being performed on the touch bar 82 by the thumb of the right hand of the photographer (a position where the touch bar 82 is touchable by the thumb of the right hand of the photographer) when the photographer grips a grip portion 90 with his/her right hand (when the photographer grips the grip portion 90 with the little finger, the ring finger, and the middle finger of his/her right hand), so that the photographer is able to depress the shutter button 61 with the index finger of his/her right hand. In other words, the touch bar 82 is disposed at a position where the touch bar 82 is capable of being operated when the photographer places his/her eye on an eyepiece portion 16, looks through a viewfinder, and is ready to depress the shutter button 61 at any time (when the photographer is in a photographing posture). The touch bar 82 is an accepting unit capable of accepting a tap operation with respect to the touch bar 82 (an operation involving touching and then releasing without moving within a predetermined period of time), leftward and rightward sliding operations (operations involving touching and moving a touch position while maintaining the touching), and the like. The touch bar 82 is an operating member that differs from the touch panel 70a, and the touch bar 82 is not equipped with a display function.

A communication terminal 10 is a communication terminal used by the digital camera 100 to communicate with a lens unit 150 (which will be described below and is attachable and detachable). The eyepiece portion 16 is an eyepiece portion of an eyepiece-type viewfinder 17 (a look-in type viewfinder), and the photographer is able to visually confirm a video image displayed on an internal electronic view finder 29 (an internal EVF 29) via the eyepiece portion 16. An ocular detecting unit 57 is an ocular detection sensor that detects whether or not the photographer has placed his/her eye on the eyepiece portion 16 (whether or not the photographer has moved his/her eye into contact with the eyepiece portion 16). A lid 202 is a lid of a slot in which the recording medium 200 (that will be described below) is stored (housed). The grip portion 90 is a holding portion that is configured in a shape that is capable of being easily gripped with the photographer's right hand when the photographer holds the digital camera 100. The shutter button 61 and the main electronic dial 71 are disposed at positions where the shutter button 61 and the main electronic dial 71 are capable of being operated by the index finger of the right hand of the photographer in a state where the digital camera 100 is held by gripping the grip portion 90 with the little finger, the ring finger, and the middle finger of the right hand of the photographer. In addition, the sub electronic dial 73 and the touch bar 82 are disposed at positions where the sub electronic dial 73 and the touch bar 82 are capable of being operated by the thumb of the right hand of the photographer in the state where the digital camera 100 is held by gripping the grip portion 90 with the little finger, the ring finger, and the middle finger of the right hand of the photographer. A thumb rest portion 91 (a thumb standby position) is a gripping member provided on the rear surface side of the digital camera 100 at a position where the thumb of the right hand gripping the grip portion 90 is capable of being easily placed in a state where none of the operating members are being operated by the photographer. The thumb rest portion 91 is configured, for example, by a rubber member or the like in order to enhance a holding force (a gripping feeling).

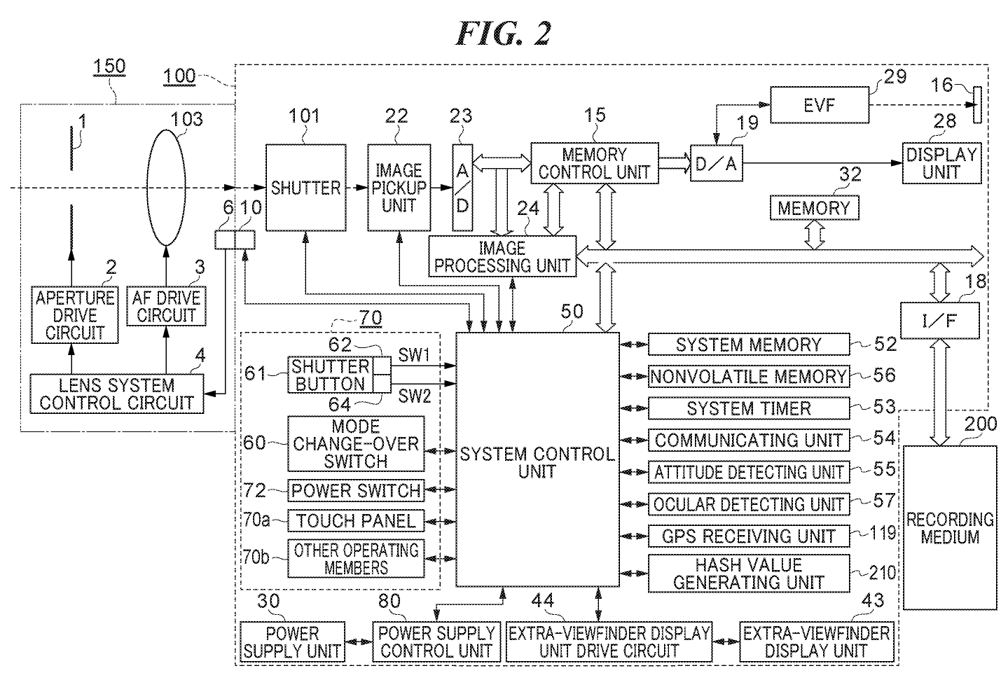

FIG. 2 is a block diagram that illustrates an example of the configuration of the digital camera 100 shown in FIG. 1A and FIG. 1B. The lens unit 150 is a lens unit mounted with an interchangeable photographing lens. While a lens 103 is usually configured by a plurality of lenses, the lens 103 is shown with only one lens in a simplified manner in FIG. 2. A communication terminal 6 is a communication terminal used by the lens unit 150 to communicate with the digital camera 100, and the communication terminal 10 is a communication terminal used by the digital camera 100 to communicate with the lens unit 150. The lens unit 150 communicates with a system control unit 50 via the communication terminal 6 and the communication terminal 10. In addition, the lens unit 150 performs the control of an aperture 1 via an aperture drive circuit 2 by using a lens system control circuit 4. Furthermore, the lens unit 150 performs focusing by displacing a position of the lens 103 via an AF drive circuit 3 by using the lens system control circuit 4.

A shutter 101 is a focal plane shutter capable of freely controlling an exposure time of an image pickup unit 22 under the control of the system control unit 50.

The image pickup unit 22 is an image pickup device (an image sensor) that is configured with a CCD solid-state image pickup device, a CMOS solid-state image pickup device, or the like, and that converts an optical image into electrical signals. The image pickup unit 22 may include an image pickup surface phase difference sensor that outputs information about a defocus amount to the system control unit 50. An A/D converter (simply referred to as “A/D” in FIG. 2) 23 converts analog signals output from the image pickup unit 22 into digital signals.

An image processing unit 24 performs prescribed processing (a pixel interpolation processing, a resizing processing such as reduction, a color conversion processing, etc.) with respect to data that has been output from the A/D converter 23 or data that has been output from a memory control unit 15. In addition, the image processing unit 24 performs a prescribed calculating processing by using the captured image data, and the system control unit 50 performs exposure control and ranging control based on a calculation result that has been obtained by the image processing unit 24. Accordingly, an automatic focusing (AF) processing, an automatic exposure (AE) processing, a preliminary light emission before flash (EF) processing, etc. in a through the lens (TTL) system are performed. Furthermore, the image processing unit 24 performs a prescribed calculating processing by using the captured image data and performs an automatic white balance (AWB) processing in the TTL system based on the obtained calculation result.

The data that has been output from the A/D converter 23 may be written into a memory 32 via the image processing unit 24 and the memory control unit 15. Also, the data that has been output from the A/D converter 23 may be written into the memory 32 via the memory control unit 15 without passing through the image processing unit 24. The memory 32 stores the image data that has been obtained by the image pickup unit 22 and has been converted into digital data by the A/D converter 23 and stores the image data to be displayed on the display unit 28 and the EVF 29. The memory 32 has a storage capacity that is sufficient to store a predetermined number of still images and store a predetermined time of moving images and audio.

In addition, the memory 32 also functions as a memory for image display (a video memory). A D/A converter (simply referred to as “D/A” in FIG. 2) 19 converts image data for display that has been stored in the memory 32 into analog signals and then supplies the analog signals to the display unit 28 and the EVF 29. In this manner, the image data for display that has been written into the memory 32 is displayed by the display unit 28 and the EVF 29 via the D/A converter 19. The display unit 28 and the EVF 29 are both displays, such as liquid crystal displays (LCDs) or organic electro-luminescence (EL) displays, and perform display in accordance with the analog signals that have been output from the D/A converter 19. It is possible to realize the live view display (the LV display) by converting the digital signals that have been subjected to A/D conversion by the A/D converter 23 and have been accumulated in the memory 32 into the analog signals with the D/A converter 19 and by sequentially transferring the analog signals to the display unit 28 or the EVF 29 and displaying the sequentially-transferred analog signals on the display unit 28 or the EVF 29. Hereinafter, an image displayed in the live view display will be referred to as a live view image (an LV image).

The system control unit 50 is a control unit configured to include at least one processor and/or at least one circuit, and controls the entire digital camera 100. The system control unit 50 is a processor and is also a circuit. The system control unit 50 realizes respective processing of the present embodiment, which will be described below, by executing programs that have been recorded (stored) in a nonvolatile memory 56. In addition, the system control unit 50 also performs display control by controlling the memory 32, the D/A converter 19, the display unit 28, the EVF 29, etc.

A system memory 52 is, for example, a random access memory (RAM). The system control unit 50 loads, into the system memory 52, constants and variables for the operations of the system control unit 50, the program that has been read out from the nonvolatile memory 56, etc.

The nonvolatile memory 56 is an electrically erasable and recordable memory and is, for example, an electrically erasable programmable read-only memory (EEPROM). The constants, the programs, etc. for the operations of the system control unit 50 are recorded (stored) in the nonvolatile memory 56. The programs here refer to programs for executing various kinds of flowcharts that will be described below in the present embodiment.

A system timer 53 is a time-measuring unit for measuring a time used in various kinds of controls and measuring a time of a built-in clock.

A communicating unit 54 transmits and receives video image signals and audio signals to and from an external device connected wirelessly or by a cable. The communicating unit 54 is also capable of being connected to a wireless local area network (a wireless LAN) or the Internet. In addition, the communicating unit 54 is also capable of communicating with the external device via Bluetooth® or Bluetooth Low Energy. The communicating unit 54 is capable of transmitting images (including LV images) that have been captured by the image pickup unit 22 and images that have been recorded on the recording medium 200, and is capable of receiving, from the external device, various kinds of information, such as image data and a moving image recording start instruction. In addition, when the communicating unit 54 has received the moving image recording start instruction from the external device, the digital camera 100 is able to notify the photographer of the receipt of the moving image recording start instruction by causing a light emitting unit 102 to emit light or emitting an electronic sound from a speaker 92. Examples of the external device that communicates with the communicating unit 54 include a smartphone, a tablet personal computer (a tablet PC), and a desktop personal computer (a desktop PC).

An attitude detecting unit 55 detects an attitude of the digital camera 100 with respect to the direction of gravitational force. Based on the attitude that has been detected by the attitude detecting unit 55, a determination is capable of being made as to whether the image captured by the image pickup unit 22 is an image captured while holding the digital camera 100 horizontally or an image captured while holding the digital camera 100 vertically. The system control unit 50 is able to add orientation information in accordance with the attitude that has been detected by the attitude detecting unit 55 to an image file of the image captured by the image pickup unit 22 or rotate and record the image. An acceleration sensor, a gyro sensor, or the like is capable of being used as the attitude detecting unit 55. By using the acceleration sensor or the gyro sensor that is the attitude detecting unit 55, it is also possible to detect the movement of the digital camera 100 (panning, tilting, lifting, whether or not it is stationary, etc.).

The ocular detecting unit 57 is the ocular detection sensor, which performs an approaching detection, that is, which detects approaching (eye-contacting) and separating (eye-separation) of the eye (an object) with respect to the eyepiece portion 16 of the eyepiece type viewfinder 17. The system control unit 50 switches display (a display state)/non-display (a non-display state) of the display unit 28 and the EVF 29 in accordance with the state that has been detected by the ocular detecting unit 57. More specifically, in the case where at least the digital camera 100 is in the photographing standby state and a switching setting of a display destination is an automatic switching, during non-eye-contacting, the display destination is set to the display unit 28 and the display of the display unit 28 is turned on, and the EVF 29 is hidden. In addition, during the eye-contacting, the display destination is set to the EVF 29 and the display of the EVF 29 is turned on, and the display unit 28 is hidden. As the ocular detecting unit 57, for example, an infrared proximity sensor is capable of being used, and in the case where an infrared proximity sensor is used as the ocular detecting unit 57, it is possible for the ocular detecting unit 57 to detect approaching of any object to the eyepiece portion 16 of the eyepiece type viewfinder 17 incorporating the EVF 29. In the case where an object approaches the eyepiece portion 16, infrared light projected from a light projecting portion (not shown) of the ocular detecting unit 57 is reflected by the object and is received by a light receiving portion (not shown) of the infrared proximity sensor. It is also possible to determine how close the object is from the eyepiece portion 16 (determine an eye-contacting distance) based on the amount of the received infrared light. In this way, the ocular detecting unit 57 performs the ocular detection that detects a proximity distance of the object to the eyepiece portion 16. In the case where an object approaching the eyepiece portion 16 from a non-eye-contacting state (a non-approaching state) within a predetermined distance has been detected, it is determined that the eye-contacting of the object has been detected. On the other hand, in the case where the object that has been detected as approaching moves away from an eye-contacting state (an approaching state) by the predetermined distance or more, it is determined that the eye-separation of the object has been detected. A threshold value for detecting the eye-contacting and a threshold value for detecting the eye-separation may differ from each other by, for example, providing a hysteresis. In addition, after the eye-contacting has been detected, it is determined that it is in the eye-contacting state until the eye-separation is detected. Moreover, after the eye-separation has been detected, it is determined that it is in the non-eye-contacting state until the eye-contacting is detected. It should be noted that the infrared proximity sensor is one example of sensors that are capable of being used as the ocular detecting unit 57, and any sensor may be used as the ocular detecting unit 57 as long as it is capable of detecting a state that is capable of being regarded as the eye-contacting.

A GPS receiving unit 119 receives, from global positioning system satellites (GPS satellites), GPS information for calculating location information and time information. The digital camera 100 receives the GPS information by the GPS receiving unit 119 and calculates the location information and the time information based on the received GPS information. The digital camera 100 is capable of adding the location information and the time information that have been calculated to the captured image (the photographed image).

A hash value generating unit 210 executes a hash function with respect to the image file to generate (calculate) a hash value. It should be noted that the system control unit 50 may perform generating a hash value instead of the hash value generating unit 210. The processing of generating a hash value will be described in detail below.

The various setting values of the digital camera 100, such as the shutter speed and the aperture, are displayed on the extra-viewfinder display unit 43 via an extra-viewfinder display unit drive circuit 44.

A power supply control unit 80 is configured to include a battery detection circuit (not shown), a DC-DC converter (not shown), a switching circuit (not shown) for switching between blocks to be energized, etc., and detects whether or not a battery has been attached, a type of the battery, a remaining battery level, and the like. In addition, the power supply control unit 80 controls the DC-DC converter based on the detection results and an instruction from the system control unit 50 and supplies the respective units including the recording medium 200 with necessary voltage for a necessary period of time. A power supply unit 30 is configured by a primary battery, such as an alkaline battery or a lithium battery; a secondary battery, such as a NiCd battery, a NiMH battery, or a lithium-ion battery; an AC adapter; or the like.

A recording medium I/F (simply referred to as “I/F” in FIG. 2) 18 is an interface with the recording medium 200, which is a memory card, a hard disk, or the like. The recording medium 200 is a recording medium, such as a memory card, for recording the captured images (the photographed images), and is, for example, a semiconductor memory, a magnetic disk, or the like.

An operating unit 70 is an input unit for accepting operations performed by the photographer (user operations) and is used to input various kinds of operation instructions to the system control unit 50. As shown in FIG. 2, the operating unit 70 includes the shutter button 61, the mode change-over switch 60, the power switch 72, the touch panel 70a, other operating members 70b, etc. In addition, the other operating members 70b include the main electronic dial 71, the sub electronic dial 73, the four-way key 74, the SET button 75, the moving image button 76, the AE lock button 77, the enlargement button 78, the playback button 79, the menu button 81, the touch bar 82, etc.

The shutter button 61 includes a first shutter switch 62 and a second shutter switch 64. The first shutter switch 62 is turned on in the middle of an operation of the shutter button 61, that is, is turned on by a so-called half-pressing (a photographing preparation instruction), and generates a first shutter switch signal SW1. Upon receiving the first shutter switch signal SW1, the system control unit 50 starts photographing preparation operations, such as the AF processing, the AE processing, the AWB processing, the EF processing, etc.

The second shutter switch 64 is turned on when the operation of the shutter button 61 is completed, that is, is turned on by a so-called full-pressing (the photographing instruction), and generates a second shutter switch signal SW2. Upon receiving the second shutter switch signal SW2, the system control unit 50 starts a series of operations in a photographing processing from reading out signals from the image pickup unit 22 to writing the captured image as an image file into the recording medium 200.

The mode change-over switch 60 switches an operation mode of the system control unit 50 between a still image photographing mode, a moving image photographing mode, the playback mode, and the like. As modes included in the still image photographing mode, there are an automatic photographing mode, an automatic scene determination mode, a manual mode, an aperture priority mode (an Av mode), a shutter speed priority mode (a Tv mode), and a program AE mode (a P mode). In addition, as the modes included in the still image photographing mode, there are various scene modes that provide photographing settings for different photographing scenes, various custom modes, etc. By operating the mode change-over switch 60, the photographer is able to directly switch to any one of these modes. Also, after temporarily switching to a photographing mode list screen by using the mode change-over switch 60, the photographer may selectively switch to any one of a plurality of modes displayed on the photographing mode list screen by using another operating member. Similarly, the moving image photographing mode may include a plurality of modes.

The touch panel 70a is a touch sensor that detects various kinds of touch operations on the display surface of the display unit 28 (an operation surface of the touch panel 70a). The touch panel 70a and the display unit 28 are capable of being configured integrally. For example, the touch panel 70a is configured so that light transmittance of the light does not interfere with the display of the display unit 28, and the touch panel 70a is attached to an upper layer of the display surface of the display unit 28. Furthermore, input coordinates on the touch panel 70a are associated with display coordinates on the display surface of the display unit 28. As a result, it becomes possible to provide a graphical user interface (a GUI) as if the photographer is able to directly operate a screen displayed on the display unit 28.

The system control unit 50 is able to detect the following operations or states on the touch panel 70a.

A new touch on the touch panel 70a of a finger or a pen that has not been touching the touch panel 70a, that is, the start of a touch (hereinafter, referred to as “a touch-down”);

A state in which a finger or a pen is touching the touch panel 70a (hereinafter, referred to as “a touch-on”);

A state in which a finger or a pen is moving while touching the touch panel 70a (hereinafter, referred to as “a touch-move”);

A finger or a pen that has been touching the touch panel 70a is removed (released) from the touch panel 70a, that is, the end of a touch (hereinafter, referred to as “a touch-up”); and

A state in which nothing is touching the touch panel 70a (hereinafter, referred to as “a touch-off”).

When the touch-down is detected, the touch-on is also detected at the same time. After the touch-down, the touch-on will normally continue to be detected unless the touch-up is detected. Also in the case where the touch-move has been detected, the touch-on is detected at the same time. Even in the case where the touch-on has been detected, if the touch position does not move, the touch-move will not be detected. When it has been detected that all fingers and/or pens that have been touching the touch panel 70a have been touched up, the touch-off occurs (the touch-off is detected).

These operations and states, as well as position coordinates on the touch panel 70a that has been touched by a finger or a pen, are notified to the system control unit 50 via an internal bus. Furthermore, based on the notified information, the system control unit 50 determines what type of operation (touch operation) has been performed on the touch panel 70a. Regarding the touch-move, the system control unit 50 is also able to determine a moving direction of a finger or a pen moving on the touch panel 70a for each vertical component and each horizontal component on the touch panel 70a based on a change in the position coordinates. In the case where a touch-move of a predetermined distance or more has been detected, the system control unit 50 determines that a slide operation has been performed. An operation, in which a finger is touched on the touch panel 70a, moved quickly for a certain distance, and then removed (released) from the touch panel 70a, is referred to as a flicking. In other words, the flicking is an operation of quickly tracing the touch panel 70a with a finger in a flicking motion. When a touch-move is detected over a predetermined distance or more at a predetermined speed or more and then a touch-up is detected, it is capable of being determined that a flicking has been performed (it is capable of being determined that a flicking has occurred following a slide operation). Furthermore, a touch operation, in which a plurality of points (for example, two points) are touched together (are multi-touched) and the touched positions are brought closer to each other, is referred to as “a pinch-in”. In addition, a touch operation, in which a plurality of points (for example, two points) are touched together (are multi-touched) and the touched positions are brought away from each other, is referred to as “a pinch-out”. The pinch-out and the pinch-in are collectively called “a pinching operation (or simply “a pinching”)”. The touch panel 70a may be any one of various types of touch panels, such as a resistive film type touch panel, a capacitive type touch panel, a surface acoustic wave type touch panel, an infrared type touch panel, an electromagnetic induction type touch panel, an image recognition type touch panel, and an optical sensor type touch panel. Furthermore, the touch panel 70a may adopt a method (type) that detects a touch by the contact of a finger or a pen with the touch panel 70a, or a method (type) that detects a touch by the approaching of a finger or a pen to the touch panel 70a.

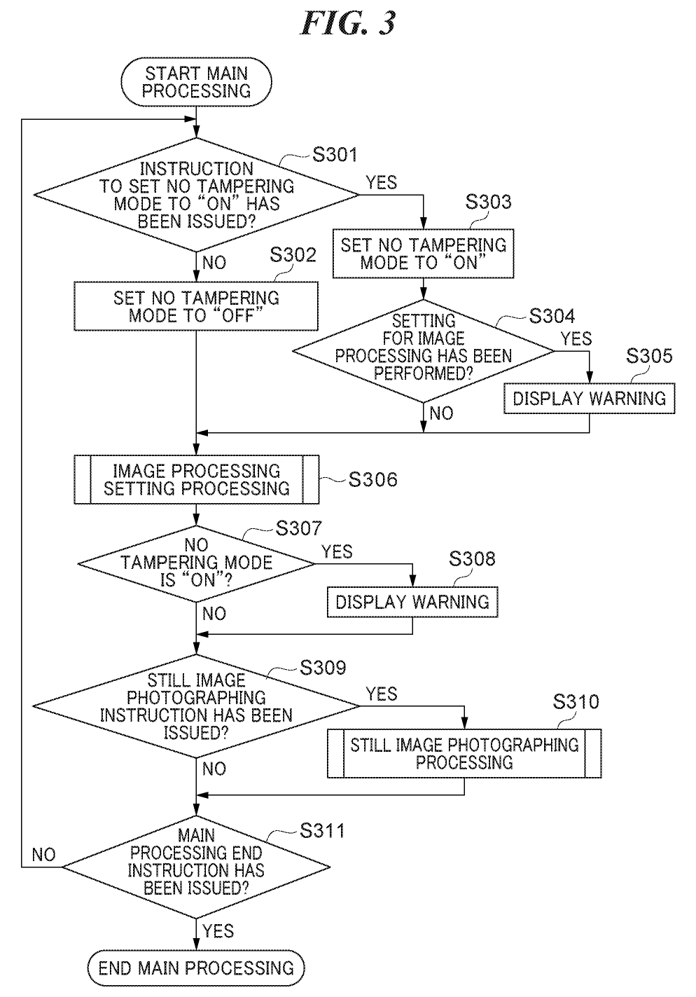

FIG. 3 is a flowchart that illustrates the procedure of a main processing executed by the digital camera 100 shown in FIG. 1A and FIG. 1B. The main processing is a series of processes for setting a no tampering mode (a tampering prevention mode) that will be described below and performing still image photographing. The main processing is realized by the system control unit 50 loading a program stored in the nonvolatile memory 56 into the system memory 52 and executing the program when the power switch 72 of the digital camera 100 is turned on.

As shown in FIG. 3, first, in S301, the system control unit 50 determines whether or not the photographer has issued an instruction to set the no tampering mode to “ON,” which enables the no tampering mode. In the present embodiment, the photographer is able to, for example, from a setting screen (not shown) displayed on the display unit 28, issue an instruction to set the no tampering mode to “ON,” which enables the no tampering mode, or issue an instruction to set the no tampering mode to “OFF,” which disables the no tampering mode. In the case where an instruction to set the no tampering mode to “ON” is determined to have been issued (YES in S301), the main processing proceeds to S303. On the other hand, in the case where an instruction to set the no tampering mode to “ON” is determined to have not been issued (NO in S301), the main processing proceeds to S302. In the present embodiment, in photographing in a state where the no tampering mode has been set to “OFF”, the digital camera 100 generates an image file that does not include history information 603, which will be described below. On the other hand, in photographing in a state where the no tampering mode has been set to “ON”, the digital camera 100 generates an image file that includes the history information 603, which will be described below. By generating an image file that includes the history information 603, it is possible to detect malicious tampering of image data or the like that constitutes the image file by using a mechanism of a hash value and a signature value that will be described below.

In S302, the system control unit 50 sets the no tampering mode to “OFF”. This setting value is stored in the memory 32. Next, the main processing proceeds to S306, which will be described below.

In S303, the system control unit 50 sets the no tampering mode to “ON”. This setting value is also stored in the memory 32.

Next, in S304, the system control unit 50 determines whether or not a setting for an image processing has been performed. The setting for the image processing is a setting performed by the photographer through an image processing setting processing performed in S306, which will be described below. In the case where the setting for the image processing is determined to have not been performed (NO in S304), the main processing proceeds to S306. For example, since the setting for the image processing has not been performed when the digital camera 100 is started up, in such a case, the main processing proceeds to S306. On the other hand, in the case where the setting for the image processing is determined to have been performed (YES in S304), the main processing proceeds to S305. For example, in the case where in the state where the no tampering mode has been set to “OFF” (S302), the photographer performs the setting for the image processing in S306, which will be described below, and then, without issuing a still image photographing instruction and a main processing end instruction (NO in S309 and NO in S311), the photographer has issued an instruction to set the no tampering mode to “ON” (YES in S301), the setting for the image processing has been performed. In such a case, the main processing proceeds to S305.

In S305, the system control unit 50 displays, on the display unit 28, a warning regarding how a history will remain. It should be noted that the details of the warning regarding how a history will remain will be described in S308, which is the same process as the process of S305.

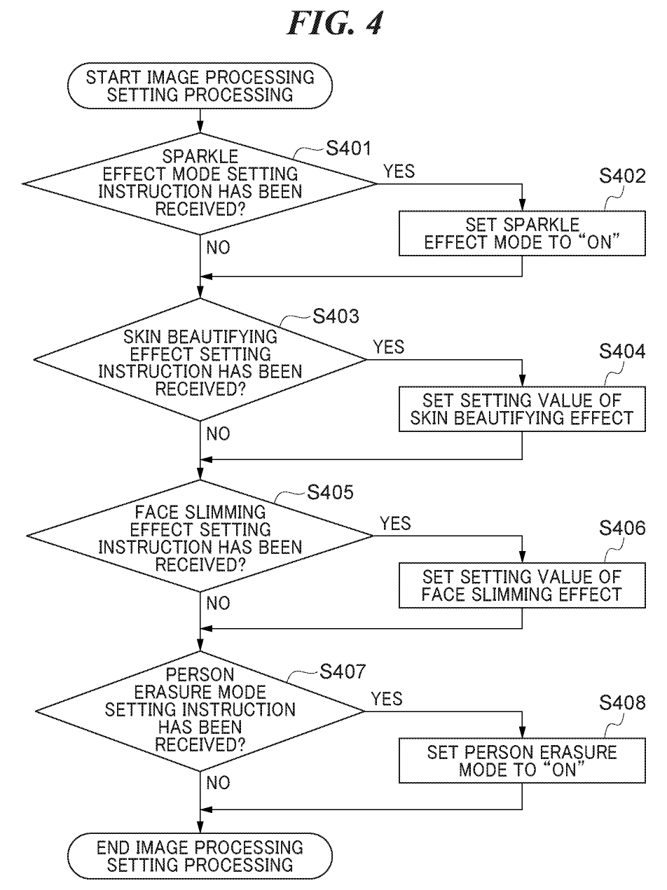

Next, in S306, the system control unit 50 performs the image processing setting processing shown in FIG. 4, which will be described below. As a result, the setting for the image processing, which is used in an image processing with respect to image data obtained by photographing performed in S310 that will be described below, is performed.

Next, in S307, the system control unit 50 determines whether or not the no tampering mode is “ON”. In the case where the no tampering mode is determined to be “ON” (YES in S307), the main processing proceeds to S308. On the other hand, in the case where the no tampering mode is determined to not be “ON” (NO in S307), that is, in the case where the no tampering mode is “OFF”, the main processing proceeds to S309.

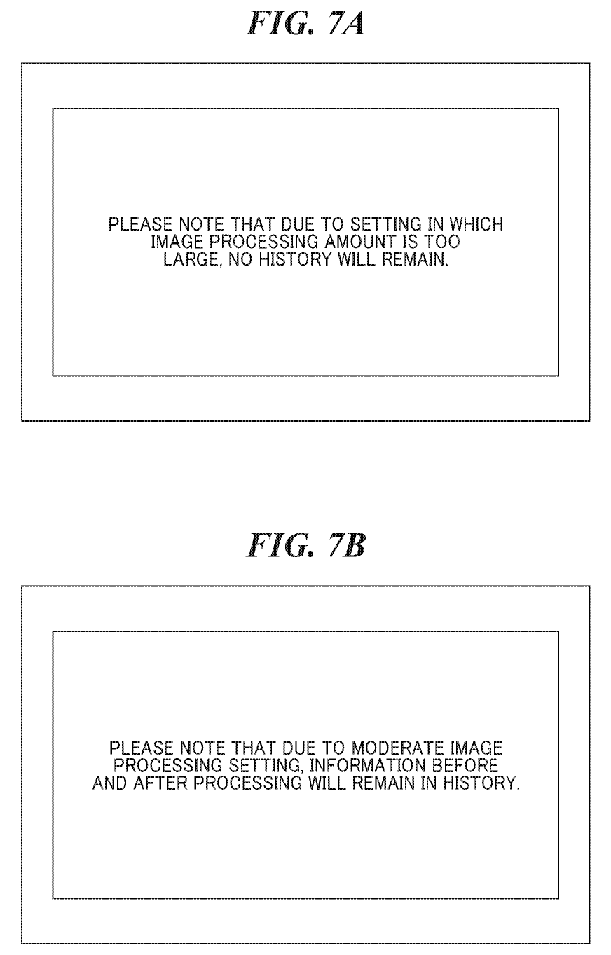

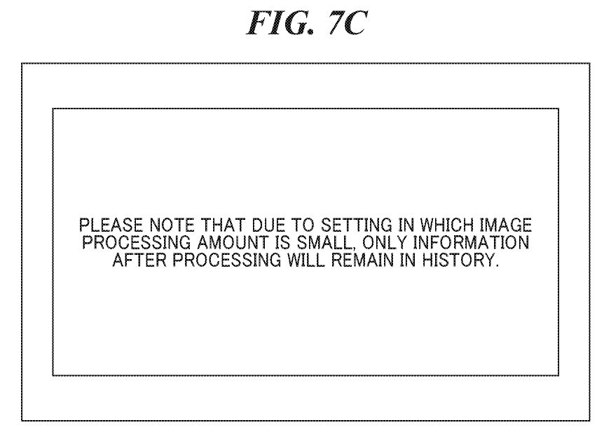

In S308, the system control unit 50 displays, on the display unit 28, a warning regarding how a history will remain. In the present embodiment, for example, in the case where the setting for the image processing that has been performed in S306 is a setting for performing an image processing that results in a processing amount greater than a predetermined processing amount, a screen shown in FIG. 7A is displayed on the display unit 28. The screen shown in FIG. 7A includes a warning message notifying that since the processing amount is too large, an image file that does not include the history information 603, which will be described below, will be generated. In addition, in the case where the setting for the image processing that has been performed in S306 is a setting for performing an image processing that results in the predetermined processing amount, a screen shown in FIG. 7B is displayed on the display unit 28. The screen shown in FIG. 7B includes a warning message notifying that the history information 603, which will be described below, includes information before processing and information after processing. In addition, in the case where the setting for the image processing that has been performed in S306 is a setting for performing an image processing that results in a processing amount smaller than the predetermined processing amount, a screen shown in FIG. 7C is displayed on the display unit 28. The screen shown in FIG. 7C includes a warning message notifying that the history information 603, which will be described below, includes information after processing.

Next, in S309, the system control unit 50 determines whether or not a still image photographing instruction has been issued by the photographer. In the present embodiment, the photographer is able to issue a still image photographing instruction by, for example, depressing the shutter button 61. In the case where a still image photographing instruction is determined to have not been issued by the photographer (NO in S309), the main processing proceeds to S311. On the other hand, in the case where a still image photographing instruction is determined to have been issued by the photographer (YES in S309), the main processing proceeds to S310.

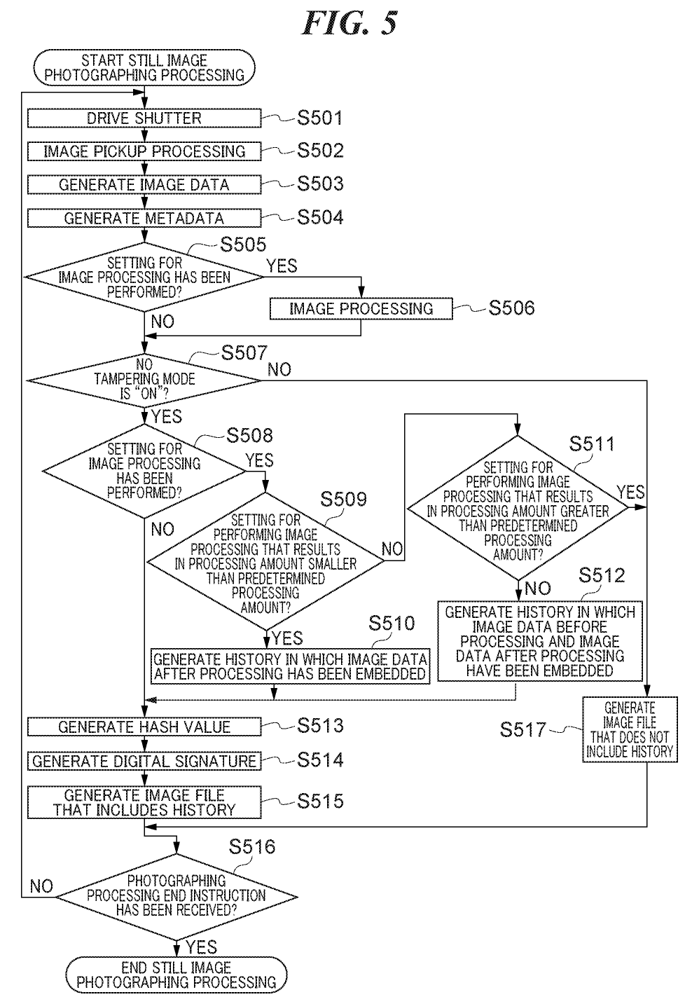

In S310, the system control unit 50 performs a still image photographing processing shown in FIG. 5, which will be described below. As a result, an image file, which includes at least the image data obtained by photographing, is generated.

Next, in S311, the system control unit 50 determines whether or not a main processing end instruction has been issued by the photographer. In the present embodiment, the photographer is able to issue a main processing end instruction by, for example, depressing the power switch 72. In the case where a main processing end instruction is determined to have not been issued by the photographer (NO in S311), the main processing returns to S301. On the other hand, in the case where a main processing end instruction is determined to have been issued by the photographer (YES in S311), the main processing ends.

FIG. 4 is a flowchart that illustrates the procedure of the image processing setting processing performed in S306 of FIG. 3. In the image processing setting processing, as the setting for the image processing, a setting that changes a subject area in the image data and a setting that changes an overall impression of the image data are performed. Examples of the setting that changes the subject area in the image data include a setting for a skin beautifying effect and a setting for a face slimming effect, which will be described below. In addition, examples of the setting that changes the overall impression of the image data include a setting for a sparkle effect mode and a setting for a person erasure mode, which will be described below.

As shown in FIG. 4, first, in S401, the system control unit 50 determines whether or not an instruction to set the sparkle effect mode (a sparkle effect mode setting instruction) has been received from the photographer. The sparkle effect mode is a function that adds a sparkling light effect to still image data or moving image data. It should be noted that in the present embodiment, the photographer is able to issue a sparkle effect mode setting instruction, for example, from a setting screen (not shown) displayed on the display unit 28 or by operating an operating member such as the mode change-over switch 60. In the case where, in S401, a sparkle effect mode setting instruction is determined to have been received from the photographer (YES in S401), the image processing setting processing proceeds to S402. On the other hand, in the case wherein, in S401, a sparkle effect mode setting instruction is determined to have not been received from the photographer (NO in S401), the image processing setting processing proceeds to S403.

In S402, the system control unit 50 sets the sparkle effect mode to “ON”, which enables the sparkle effect mode. This setting value is stored in the memory 32. Next, the image processing setting processing proceeds to S403.

In S403, the system control unit 50 determines whether or not an instruction to set the skin beautifying effect (a skin beautifying effect setting instruction) has been received from the photographer. The skin beautifying effect is a function that processes skin to make the skin look smoother and brighter. By using the skin beautifying effect, blemishes and dullness in skin of a person area in the image data become unobtrusive. It should be noted that in the present embodiment, when using the skin beautifying effect, the photographer designates one of “weak”, “medium”, and “strong”, which indicates a degree of processing for the skin beautifying effect. In the case where the “weak” of the skin beautifying effect is designated, the skin of the person area in the image data becomes slightly smoother, and light blemishes and dullness become unobtrusive. In the case where the “medium” of the skin beautifying effect is designated, the skin of the person area in the image data becomes smoother, and blemishes and dullness become more unobtrusive. In the case where the “strong” of the skin beautifying effect is designated, the skin of the person area in the image data becomes greatly smoother, blemishes and dullness disappear, and the texture of the skin looks like porcelain. It should be noted that in the present embodiment, the photographer is able to issue a skin beautifying effect setting instruction, for example, by selecting one of the “weak”, the “medium”, and the “strong” of the skin beautifying effect on a setting screen (not shown) displayed on the display unit 28. In the case where, in S403, a skin beautifying effect setting instruction is determined to have been received from the photographer (YES in S403), the image processing setting processing proceeds to S404. On the other hand, in the case where, in S403, a skin beautifying effect setting instruction is determined to have not been received from the photographer (NO in S403), the image processing setting processing proceeds to S405.

In S404, the system control unit 50 sets a setting value of the skin beautifying effect, which has been selected by the photographer from among the “weak”, the “medium”, and the “strong”. This setting value of the skin beautifying effect is also stored in the memory 32. Next, the image processing setting processing proceeds to S405.

In S405, the system control unit 50 determines whether or not an instruction to set the face slimming effect (a face slimming effect setting instruction) has been received from the photographer. The face slimming effect is a function that makes a facial contour appear tighter. It should be noted that in the present embodiment, when using the face slimming effect, the photographer designates one of 1 to 10, which indicates a degree of processing for the face slimming effect. 1 indicates the smallest degree of processing for the face slimming effect, the larger this setting value, the greater the degree of processing for the face slimming effect, and 10 indicates the largest degree of processing for the face slimming effect. It should be noted that in the present embodiment, the photographer is able to issue a face slimming effect setting instruction, for example, by selecting one of 1 to 10 of the face slimming effect on a setting screen (not shown) displayed on the display unit 28. In the case where, in S405, a face slimming effect setting instruction is determined to have been received from the photographer (YES in S405), the image processing setting processing proceeds to S406. On the other hand, in the case where, in S405, a face slimming effect setting instruction is determined to have not been received from the photographer (NO in S405), the image processing setting processing proceeds to S407.

In S406, the system control unit 50 sets a setting value of the face slimming effect, which has been selected by the photographer from among 1 to 10. This setting value of the face slimming effect is also stored in the memory 32. Next, the image processing setting processing proceeds to S407.

In S407, the system control unit 50 determines whether or not an instruction to set the person erasure mode (a person erasure mode setting instruction) has been received from the photographer. The person erasure mode is a function that erases a specific person area from the image data. The erased specific person area is automatically filled in with the background, resulting in a natural-looking finish. It should be noted that in the present embodiment, the photographer is able to issue a person erasure mode setting instruction, for example, from a setting screen (not shown) displayed on the display unit 28, or by operating an operating member such as the mode change-over switch 60. In the case where, in S407, a person erasure mode setting instruction is determined to have been received from the photographer (YES in S407), the image processing setting processing proceeds to S408. On the other hand, in the case where, in S407, a person erasure mode setting instruction is determined to have not been received from the photographer (NO in S407), the image processing setting processing ends.

In S408, the system control unit 50 sets the person erasure mode to “ON”, which enables the person erasure mode. This setting value is also stored in the memory 32. After that, the image processing setting processing ends.

It should be noted that in the present embodiment, in S401, as an example, a configuration has been described in which it is determined whether or not a sparkle effect mode setting instruction has been received, but the present disclosure is not limited to this configuration. For example, in S401, it may be determined whether or not an instruction to set another image processing mode other than the sparkle effect mode has been received as an instruction to set the setting that changes the overall impression of the image data. The another image processing mode is an image processing mode that changes an overall impression of the image, such as a toy camera style, a diorama style, an oil painting style, a watercolor style, a fisheye style, a monochrome style, a soft focusing style, or the like.

FIG. 5 is a flowchart that illustrates the procedure of the still image photographing processing performed in S310 of FIG. 3. The still image photographing processing shown in FIG. 5 starts when a photographing start operation, such as depressing the shutter button 61, is accepted, and the still image photographing processing shown in FIG. 5 ends when a photographing end operation, such as stopping depressing the shutter button 61, is accepted.

As shown in FIG. 5, first, in S501, in order to control the exposure time, the system control unit 50 performs control to drive the shutter 101 disposed on the subject side of the image pickup unit 22.

Next, in S502, the system control unit 50 performs an image pickup processing, in which the image pickup unit 22 converts light from a subject received through the shutter 101 into electrical signals (analog image data).

Next, in S503, the system control unit 50 performs image processing such as a development processing and an encoding processing with respect to the electrical signals that have been obtained by the image pickup processing described above, thereby generating image data.

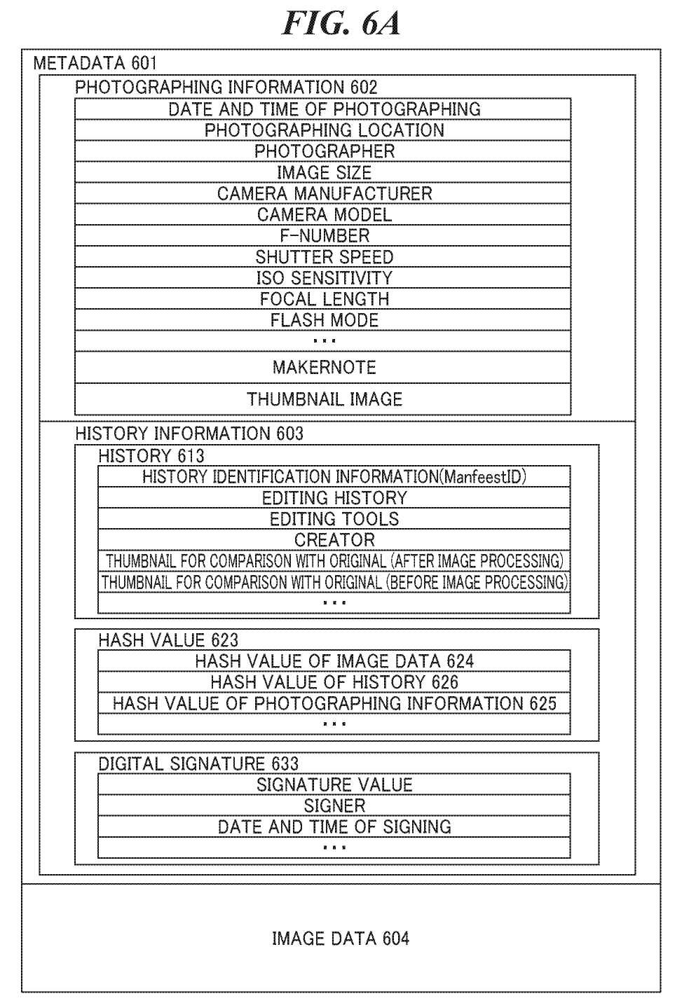

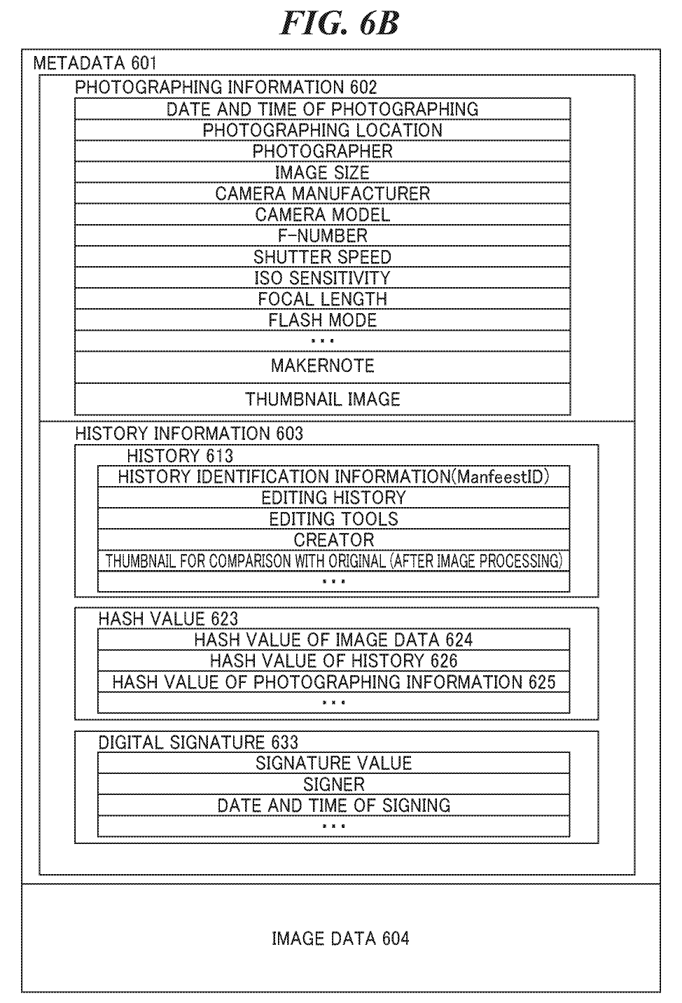

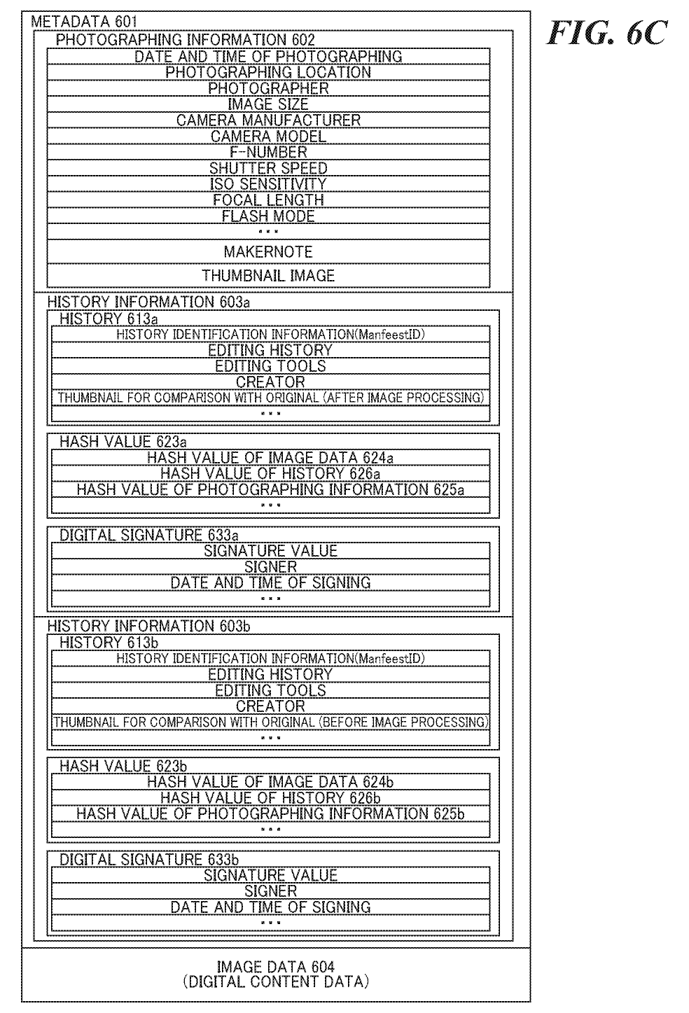

Next, in S504, the system control unit 50 generates metadata 601 shown in FIG. 6A. The metadata 601 includes photographing information 602 and the history information 603. The photographing information 602 is information at the time when the image pickup processing for generating image data 604 has been executed, such as a date and time of photographing, the photographer, an image size, a manufacturer and a model of the digital camera 100, various kinds of photographing parameters that have been set at the time of photographing, a photographing location, a thumbnail image, etc. The photographing information 602 is generated in accordance with a predetermined technical standard (for example, exchangeable image file format (EXIF)).

The history information 603 is information for certifying (verifying) the credibility (authenticity) of the image data 604 and is used when verifying the provenance (source) and history of the image data 604. The history information 603 is generated in accordance with a predetermined technical standard (for example, coalition for content provenance and authenticity (C2PA)) and has a specified structure. The history information 603 includes a history (Assertion) 613 and includes a hash value 623 and a digital signature 633 for assuring the history 613. The history 613 includes information such as history identification information (Manifest ID) for uniquely identifying the history 613, an editing history indicating the editing content of the image data 604, editing tools indicating tools used for the editing, and a creator of the image data 604. Here, in the present embodiment, since the image data 604 has just been generated by photographing and has not been edited by an editing application or the like, the editing history includes information indicating “generation”, and the editing tools include information indicating the digital camera 100.

Next, in S505, the system control unit 50 determines whether or not the setting for the image processing has been performed. The setting for the image processing is the setting performed by the photographer through the image processing setting processing performed in S306, which has been described above. In the case where, in S505, the setting for the image processing is determined to have been performed (YES in S505), the still image photographing processing proceeds to S506. On the other hand, in the case where, in S505, the setting for the image processing is determined to have not been performed (NO in S505), the still image photographing processing proceeds to S507.

In S506, the system control unit 50 performs the image processing with respect to the image data that has been generated in S503 based on the setting for the image processing that has been performed through the image processing setting processing performed in S306, which has been described above.

Next, in S507, the system control unit 50 determines whether or not the no tampering mode is “ON”. In the case where, in S507, the no tampering mode is determined to be “ON” (YES in S507), the still image photographing processing proceeds to S508.

In S508, the system control unit 50 determines whether or not the setting for the image processing has been performed. In the case where, in S508, the setting for the image processing is determined to have been performed (YES in S508), the still image photographing processing proceeds to S509.

In S509, the system control unit 50 determines whether or not the setting for the image processing that has been used in the image processing performed in S506 is a setting for performing an image processing that results in a processing amount smaller than the predetermined processing amount. The setting for performing the image processing that results in the processing amount smaller than the predetermined processing amount is a setting for performing an image processing with respect to the image data that has been generated in S503 to an extent that a person area included in the image data that has been generated in S503 is capable of being recognized as the person himself/herself. Examples of the setting for performing the image processing that results in the processing amount smaller than the predetermined processing amount include the “weak” of the skin beautifying effect and 1 to 4 of the face slimming effect. In the case where it is determined that the setting for the image processing that has been used in the image processing performed in S506 is the setting for performing the image processing that results in the processing amount smaller than the predetermined processing amount (YES in S509), the still image photographing processing proceeds to S510. On the other hand, in the case where it is determined that the setting for the image processing that has been used in the image processing performed in S506 is not the setting for performing the image processing that results in the processing amount smaller than the predetermined processing amount (NO in S509), the still image photographing processing proceeds to S511.

In S510, the system control unit 50 generates the history 613 shown in FIG. 6B in which image data after processing (processed image data) has been embedded as a thumbnail for comparison with original. Next, the still image photographing processing proceeds to S513, which will be described below.

In S511, the system control unit 50 determines whether or not the setting for the image processing that has been used in the image processing performed in S506 is a setting for performing an image processing that results in a processing amount greater than the predetermined processing amount. The setting for performing the image processing that results in the processing amount greater than the predetermined processing amount is a setting for performing an image processing with respect to the image data that has been generated in S503 that involves significant changes that make it impossible to claim that the image data is not tampered with. Examples of the setting for performing the image processing that results in the processing amount greater than the predetermined processing amount include the sparkle effect mode, the “strong” of the skin beautifying effect, 6 to 10 of the face slimming effect, and the person erasure mode. In addition, a setting for the image processing mode that performs an image processing in the toy camera style, the diorama style, the oil painting style, the watercolor style, the fisheye style, the monochrome style, the soft focusing style, or the like is also included in the setting for performing the image processing that results in the processing amount greater than the predetermined processing amount. In the case where it is determined that the setting for the image processing that has been used in the image processing performed in S506 is not the setting for performing the image processing that results in the processing amount greater than the predetermined processing amount (NO in S511), that is, in the case where the setting for the image processing that has been used in the image processing performed in S506 is a setting for performing an image processing that results in the predetermined processing amount, the still image photographing processing proceeds to S512. Examples of the setting for performing the image processing that results in the predetermined processing amount include the “medium” of the skin beautifying effect and 5 of the face slimming effect.

In S512, the system control unit 50 generates the history 613 shown in FIG. 6A in which both image data before processing (unprocessed image data) and the image data after processing (the processed image data) have been embedded as thumbnails for comparison with the original.

Next, in S513, the system control unit 50 generates the hash value 623 by executing a hash function with respect to binary data of each of the image data 604 and the history 613 that was been generated in S510 or S512. In the present embodiment, in the case where, in S505, the setting for the image processing is determined to have been performed, the image data 604 is image data that has been subjected to the image processing of S506 (image data, with respect to which the image processing of S506 has been performed). On the other hand, in the case where, in S505, the setting for the image processing is determined to have not been performed, the image data 604 is the image data that has been generated in S503. It should be noted that a hash value may also be generated based on binary data of the photographing information 602.

Next, in S514, the system controller 50 generates the digital signature 633. The digital signature 633 includes information indicating a signature value, a signer, and a date and time of signing. The signature value is generated by encrypting the generated hash value 623 by using a private key that has been prepared in advance. A public key paired with the private key used here is also stored in the digital signature 633. It should be noted that in this case, in order to prove that an administrator of the public key is a trustworthy manufacturer, information indicating the manufacturer of the digital camera 100 as the signer or a public key certificate indicating that the public key has been authenticated by a certificate authority may be stored. By adding the digital signature 633 including such a signer to an image file, it is possible to show that the image file is trustworthy. It should be noted that the model of the digital camera 100 may be used as the signer instead of the manufacturer of the digital camera 100. In addition, a date and time when the generation of the digital signature is completed is stored in the date and time of signing.

Next, in S515, the system control unit 50 adds the photographing information 602 and the history information 603 to the image data 604 as the metadata 601, and the system control unit 50 generates an image file that includes the history. For example, in the case where the setting for the image processing that has been used in the image processing performed in S506 is the setting for performing the image processing that results in the processing amount smaller than the predetermined processing amount, an image file shown in FIG. 6B is generated. In the history 613 of the image file shown in FIG. 6B, the image data after processing has been embedded as the thumbnail for comparison with original. In addition, in the case where the setting for the image processing that has been used in the image processing performed in S506 is the setting for performing the image processing that results in the predetermined processing amount, an image file shown in FIG. 6A is generated. In the history 613 of the image file shown in FIG. 6A, the image data before processing and the image data after processing have been embedded as the thumbnails for comparison with original. Here, the image data 604 is generated in accordance with a still image or moving image format, such as JPEG format or MPEG format.

Next, in S516, the system control unit 50 determines whether or not an instruction to end the photographing processing (a photographing processing end instruction) has been received from the photographer. In the case where a photographing processing end instruction is determined to have not been received from the photographer (NO in S516), the still image photographing processing returns to S501. On the other hand, in the case where a photographing processing end instruction is determined to have been received from the photographer (YES in S516), the still image photographing processing ends.

In the case where, in S507, the no tampering mode is not “ON” (NO in S507), that is, in the case where the no tampering mode is “OFF”, the still image photographing processing proceeds to S517. In addition, also in the where, in S511, it is determined that the setting for the image processing that has been used in the image processing performed in S506 is the setting for performing the image processing that results in the processing amount greater than the predetermined processing amount (YES in S511), the still image photographing processing proceeds to S517.

In S517, the system control unit 50 adds, as the metadata 601, the photographing information 602 to the image data 604 that has been generated in S503, and generates an image file that does not include the history. The image data 604 that has been generated in S503 is also generated in accordance with a still image or moving image format, such as JPEG format or MPEG format. After that, the still image photographing processing proceeds to S516.

As described above, in the present embodiment, when the digital camera 100 performs still image photographing, an image file is generated. It should be noted that the image file may be edited by an application or the like. In the case where the image file has been edited by using approved editing tools in a legitimate procedure, based on the editing content, the history information 603 is newly generated in accordance with a predetermined technical standard, and is added to and stored in the metadata 601 of the image file. The history information 603 is newly generated every time the image file is edited and is added to and stored in the metadata 601 of the image file. On the other hand, in the case where editing of the image file has been performed by using unapproved editing tools or in an illegitimate procedure, the history information 603 may not be added to the image file, or the history information that has been added to the image file may not conform to a predetermined technical standard.

In addition, by generating a hash value and a signature value, it becomes possible to detect tampering with the image file. For example, a hash function is executed with respect to the binary data of the image data 604 of the image file to generate a hash value. Furthermore, the generated hash value is compared with a hash value 624 of image data of an image file, which is a judgment target. As a result, it becomes possible to verify whether or not the image data has been tampered with. Similarly, a hash function is executed with respect to the binary data of the photographing information 602 of the image file to generate a hash value. Furthermore, the generated hash value is compared with each hash value of photographing information of the image file, which is a judgment target. As a result, it becomes possible to verify whether or not the date and time of photographing, the photographing location, the photographer, and other data have been tampered with. It should be noted that as shown in the present embodiment, it is possible to guarantee the provenance (history) of only selected data (that is, only selected data is capable of being subject to provenance (history) assurance), and the technique according to the present disclosure is applicable not only to an image pickup apparatus but also to an editing application or the like.

In addition, a hash function is executed with respect to the binary data of the history 613 to generate a hash value. Furthermore, the generated hash value is compared with a hash value 626 of a history of the image file, which is a judgment target. As a result, it becomes possible to verify whether or not the history data has been tampered with. It should be noted that in this case, the binary data to be compared may be compared in smaller units such as the editing history, the creator (a production source), the thumbnail data, and the metadata. In addition, the signature value is capable of being decrypted by using the public key, and if the hash values match, it can be determined that the signature value has been successfully verified. In this way, it is possible to incorporate a mechanism for detecting tampering into the image file.

According to the embodiment described above, in the case where the no tampering mode is “ON” and the setting for the image processing satisfies a predetermined condition, the image file shown in FIG. 6A, which includes the image data 604 and the history information 603, is generated. The history information 603 of the image file shown in FIG. 6A includes at least both the image data before processing and the image data after processing. As a result, it is possible to provide an image file that allows confirmation of a state before processing in the case where the setting for the image processing satisfies the predetermined condition in the no tampering mode.

In addition, in the embodiment described above, in the case where the setting for the image processing satisfies the predetermined condition, the setting for the image processing is the setting for performing the image processing that results in the predetermined processing amount. As a result, it is possible to provide an image file that allows confirmation of a state before processing of the image data 604 that has been obtained by the image processing that results in the predetermined processing amount.

In addition, in the embodiment described above, in the case where the no tampering mode is “ON” and the setting for the image processing is the setting for performing the image processing that results in the predetermined processing amount, the screen shown in FIG. 7B is displayed on the display unit 28. The screen shown in FIG. 7B includes the warning message notifying that the history information 603 includes the information before processing and the information after processing. As a result, it is possible to cause the photographer to recognize that the generated image file includes not only the information after processing (the image data after processing) but also the information before processing (the image data before processing).

In addition, in the embodiment described above, in the case where the no tampering mode is “ON” and the setting for the image processing is the setting for performing the image processing that results in the processing amount greater than the predetermined processing amount, an image file, which includes the image data 604 but does not include the history information 603, is generated. In other words, in the case where an image processing that involves significantly large changes from before processing has been performed with respect to the image data that has been obtained by photographing with the digital camera 100, the image data after processing that has been obtained by this image processing will be excluded from the scope of authenticity guarantee. As a result, it is possible to provide, as a target of authenticity guarantee, only image data that has been obtained by an image processing that results in a processing amount equal to or less than the predetermined processing amount, and therefore, it is possible to prevent unnecessary confusion from being given to viewers of the image data.

In addition, in the embodiment described above, in the case where the no tampering mode is “ON” and the setting for the image processing is the setting for performing the image processing that results in the processing amount greater than the predetermined processing amount, the screen shown in FIG. 7A is displayed on the display unit 28. The screen shown in FIG. 7A includes the warning message notifying that since the processing amount is too large, an image file that does not include the history information 603 will be generated. As a result, it is possible to cause the photographer to recognize that the generated image file does not include the history information 603.

In addition, in the embodiment described above, in the case where the no tampering mode is “ON” and the setting for the image processing is the setting for performing the image processing that results in the processing amount smaller than the predetermined processing amount, the image file shown in FIG. 6B, which includes the image data 604 and the history information 603, is generated. The history information 603 of the image file shown in FIG. 6B includes the image data after processing, but does not include the image data before processing. Here, since the image data after processing, which has been obtained by the image processing that results in the processing amount smaller than the predetermined processing amount, has an extremely small change from before processing, the need for the photographer or the viewer to confirm (check) a state before processing such image data is extremely low. It is preferable that the history information to be added to such image data does not include the image data before processing, so as to prevent the file size of the entire image file from becoming large. Accordingly, in the present embodiment, in the case where the no tampering mode is “ON” and the setting for the image processing is the setting for performing the image processing that results in the processing amount smaller than the predetermined processing amount, the image file shown in FIG. 6B, which includes the image data 604 and the history information 603, is generated. The history information 603 of the image file shown in FIG. 6B includes the image data after processing, but does not include the image data before processing. As a result, it is possible to prevent the file size of an image file including the image data, which has been obtained by the image processing that results in the processing amount smaller than the predetermined processing amount, from becoming unnecessarily large.

In addition, in the embodiment described above, in the case where the no tampering mode is “ON” and the setting for the image processing is the setting for performing the image processing that results in the processing amount smaller than the predetermined processing amount, the screen shown in FIG. 7C is displayed on the display unit 28. The screen shown in FIG. 7C includes the warning message notifying that the history information 603 shown in FIG. 6B includes the information after processing. As a result, it is possible to cause the photographer to recognize that the generated image file includes the information after processing (the image data after processing) but does not include the information before processing (the image data before processing).

In addition, in the embodiment described above, the setting for the image processing includes the setting that changes the subject area in the image data. The setting that changes the subject area in the image data is the setting for the skin beautifying effect or the setting for the face slimming effect. As a result, it is possible to determine the configuration of the history information 603 included in the image file based on the setting for the skin beautifying effect and/or the setting for the face slimming effect.

In addition, in the embodiment described above, the setting for the image processing includes the setting that changes the overall impression of the image data. The setting that changes the overall impression of the image data is the setting for the sparkle effect mode, the setting for the person erasure mode, or the setting for the image processing mode that performs the image processing in the toy camera style, the diorama style, the oil painting style, the watercolor style, the fisheye style, the monochrome style, or the soft focusing style. As a result, it is possible to determine the configuration of the history information 603 included in the image file based on these settings.

In addition, in the embodiment described above, according to the photographer having set the no tampering mode to “ON”, one of the screen shown in FIG. 7A, the screen shown in FIG. 7B, and the screen shown in FIG. 7C is displayed on the display unit 28. As a result, when the no tampering mode for generating an image file that includes the history information 603 has been set to “ON” by the photographer, it is possible to notify a warning message corresponding to the configuration of the history information, which has been determined based on the setting for the image processing that has been performed by the photographer.

In addition, in the embodiment described above, in the case where the no tampering mode is “ON”, according to the photographer having performed the setting for the image processing, one of the screen shown in FIG. 7A, the screen shown in FIG. 7B, and the screen shown in FIG. 7C is displayed on the display unit 28. As a result, when a setting for the image processing has been performed by the photographer, it is possible to notify the photographer of a warning message corresponding to the configuration of the history information, which has been determined based on this setting for the image processing.

It should be noted that in the present embodiment, in S512, as shown in FIG. 6A, a configuration has been described in which both the image data before processing and the image data after processing have been embedded within one history 613 as the thumbnails for comparison with original, but the configuration of the history 613 is not limited to this configuration. For example, as shown in FIG. 6C, a configuration of dividing the history 613 into a history 613a, in which the image data before processing has been embedded as a thumbnail for comparison with original, and a history 613b, in which the image data after processing has been embedded as a thumbnail for comparison with original, may be adopted. Even with such a configuration, the same effects as those of the embodiment described above are capable of being achieved.

According to the present disclosure, it is possible to provide an image file that allows confirmation of a state before processing in the case where the setting for the image processing satisfies the predetermined condition in the no tampering mode.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2025-008474, which was filed on January 21, 2025 and which is hereby incorporated by reference herein in its entirety.

What is claimed is:

1. An image pickup apparatus comprising:
an image pickup unit;
at least one processor; and
a memory coupled to the at least one processor and storing instructions that, when executed by the at least one processor, cause the at least one processor to:
switch a no tampering mode for generating an image file, which includes image data that has been generated by the image pickup unit and history information for certifying credibility of the image data, between enabled and disabled;
perform an image processing with respect to the image data based on a setting for an image processing that has been performed by a photographer; and
generate an image file that includes at least the image data, and
wherein in a case where the no tampering mode is enabled and the setting for the image processing satisfies a predetermined condition, an image file that includes the image data and the history information is generated, and the history information includes at least image data before the image processing is performed and image data that has been subjected to the image processing.

2. The image pickup apparatus according to claim 1, wherein
in a case where the setting for the image processing satisfies the predetermined condition, the setting for the image processing is a setting for performing an image processing that results in a predetermined processing amount.

3. The image pickup apparatus according to claim 2, wherein
the at least one processor is caused to, in a case where the no tampering mode is enabled and the setting for the image processing is the setting for performing the image processing that results in the predetermined processing amount, notify that the history information includes both the image data before the image processing is performed and the image data that has been subjected to the image processing.

4. The image pickup apparatus according to claim 2, wherein
in a case where the no tampering mode is enabled and the setting for the image processing is a setting for performing an image processing that results in a processing amount greater than the predetermined processing amount, the at least one processor generates an image file that includes the image data but does not include the history information.

5. The image pickup apparatus according to claim 4, wherein
the at least one processor is caused to, in the case where the no tampering mode is enabled and the setting for the image processing is the setting for performing the image processing that results in the processing amount greater than the predetermined processing amount, notify that the image file does not include the history information.

6. The image pickup apparatus according to claim 2, wherein
in a case where the no tampering mode is enabled and the setting for the image processing is a setting for performing an image processing that results in a processing amount smaller than the predetermined processing amount, the at least one processor generates an image file that includes the image data and the history information, and the history information includes the image data that has been subjected to the image processing but does not include the image data before the image processing is performed.

7. The image pickup apparatus according to claim 6, wherein
the at least one processor is caused to, in the case where the no tampering mode is enabled and the setting for the image processing is the setting for performing the image processing that results in the processing amount smaller than the predetermined processing amount, notify that the history information includes the image data that has been subjected to the image processing.

8. The image pickup apparatus according to claim 1, wherein
the setting for the image processing includes a setting that changes a subject area in the image data.

9. The image pickup apparatus according to claim 8, wherein
the setting that changes the subject area in the image data is a setting for processing skin to make the skin look smoother and brighter.

10. The image pickup apparatus according to claim 9, wherein
the setting for processing skin to make the skin look smoother and brighter is designated by the photographer from among weak, medium, and strong that each indicates a degree of processing.

11. The image pickup apparatus according to claim 8, wherein
the setting that changes the subject area in the image data is a setting for making a facial contour appears tighter.

12. The image pickup apparatus according to claim 11, wherein
the setting for making a facial contour appears tighter is designated by the photographer from among a plurality of setting values that each indicates a degree of processing.

13. The image pickup apparatus according to claim 1, wherein
the setting for the image processing includes a setting that changes an overall impression of the image data.

14. The image pickup apparatus according to claim 13, wherein
the setting that changes the overall impression of the image data is a setting for a mode that adds a sparkling light effect to the image data.

15. The image pickup apparatus according to claim 13, wherein
the setting that changes the overall impression of the image data is a setting for a mode that erases a specific person area from the image data.

16. The image pickup apparatus according to claim 13, wherein
the setting that changes the overall impression of the image data is a setting for an image processing mode that performs an image processing in a toy camera style, a diorama style, an oil painting style, a watercolor style, a fisheye style, a monochrome style, or a soft focusing style.

17. The image pickup apparatus according to claim 1, wherein
the history information includes first history information and second history information,
the first history information includes the image data before the image processing is performed, and
the second history information includes the image data that has been subjected to the image processing.

18. The image pickup apparatus according to claim 3, wherein
the at least one processor, according to the photographer having set the no tampering mode to enabled, makes a notification.

19. The image pickup apparatus according to claim 3, wherein
the at least one processor, in a case where the no tampering mode is enabled, according to the photographer having performed the setting for the image processing, makes a notification.

20. A control method for an image pickup apparatus that comprises an image pickup unit, the control method comprising:
a step of switching a no tampering mode for generating an image file, which includes image data that has been generated by the image pickup unit and history information for certifying credibility of the image data, between enabled and disabled;
a step of performing an image processing with respect to the image data based on a setting for an image processing that has been performed by a photographer; and
a generating step of generating an image file that includes at least the image data, and
wherein in the generating step, in a case where the no tampering mode is enabled and the setting for the image processing satisfies a predetermined condition, an image file that includes the image data and the history information is generated, and the history information includes at least image data before the image processing is performed and image data that has been subjected to the image processing.

21. A non-transitory computer-readable storage medium storing computer-executable instructions for causing a computer to execute a control method for an image pickup apparatus that comprises an image pickup unit, the control method comprising:
a step of switching a no tampering mode for generating an image file, which includes image data that has been generated by the image pickup unit and history information for certifying credibility of the image data, between enabled and disabled;
a step of performing an image processing with respect to the image data based on a setting for an image processing that has been performed by a photographer; and
a generating step of generating an image file that includes at least the image data, and
wherein in the generating step, in a case where the no tampering mode is enabled and the setting for the image processing satisfies a predetermined condition, an image file that includes the image data and the history information is generated, and the history information includes at least image data before the image processing is performed and image data that has been subjected to the image processing.
